(19) United States
(12) Patent Application Publication
(10) Pub. No.: US 2009/0160728 A1
(43) Pub. Date: Jun. 25, 2009

(54) UNCORRELATED ANTENNAS FORMED OF ALIGNED CARBON NANOTUBES

(75) Inventors: Rudy M. Emrick, Gilbert, AZ (US); Antonio Faraone, Fort Lauderdale, FL (US); Eric Krenz, Crystal Lake, IL (US); Istvan Szini, Grayslake, IL (US)

Correspondence Address: INGRASSIA FISHER & LORENZ, P.C. (MOT), 7010 E. Cochise Road, SCOTTSDALE, AZ, 85253, US

(73) Assignee: Motorola, Inc., Schaumburg, IL (US)

(21) Appl. No.: 11/962,891

(22) Filed: Dec. 21, 2007

(51) Int. Cl. H01Q 21/00

(52) U.S. Cl. 343/893; 977/742

(57) ABSTRACT

An uncorrelated RF antenna system (100) having uncorrelated antennas (102, 104) disposed in close relationship for use with mobile communication device transmitters and/or receivers (300). A first antenna (102) comprises a first plurality of elongated nanostructures (106) aligned in a first direction (110), and a second antenna (104) spatially disposed from the first antenna (102) comprises a second plurality of elongated nanostructures (108) aligned in a second direction (112) substantially orthogonal to the first direction (110). When a signal is received, an E polarization is created in the first antenna (102) orthogonal to an E polarization created in the second antenna (104).

### FIELD

The present invention generally relates to transmitters and receivers and more particularly to a method and structure of uncorrelated antennas for use with transmitters and receivers.

### BACKGROUND

Global telecommunication systems, such as cell phones and two way radios, are migrating to higher frequencies and data rates due to increased consumer demand on usage and the desire for more over-the-air content. Current mobile devices are challenged by the increased functionality and complexity of multi-modes, multi-bands, and multi-standards, and progressing beyond 3G with the increasing requirement of multimedia, mobile internet, connected home solutions, sensor-network, high-speed data connectivity such as Bluetooth, RFID, WLAN, WiMAX, UWB, and 4G. Limited battery power and tight design space will become bottlenecks for the high integration and development of mobile devices. The tight design space is especially challenging for RF technologies and the requisite design/fabrication of adaptive/tunable antennas and antenna arrays. RF antennas using nano-sized conducting structures with low power dissipation will be necessary.

Known antennas ranging from macro-size to micro-size, are based on a top-down approach, and are bulky. They have difficulties in meeting performance and power-consumption requirements, particularly with increased frequency, functionality and complexity of multi-modes, multi-bands, and multi standards for seamless connectivity. Size and frequency limitation such as the Terahertz gap have been reached. With the increase of high frequency for high data rate communications, skin effect and dielectric losses become more of an issue and cause loss of efficiency for these conventional solid and bulky antennas, thereby impacting power consumption.

The size of personal portable electronics devices is a key product differentiator and one of the most significant reasons that consumers choose specific models. From a business standpoint, the size (typically smaller, and its form and appearance) may increase market appeal and consequently market share and profit margin.

Many wireless communication systems, presently deployed or envisioned, make use of multiple antenna architectures at one or both ends of the communication link to increase system capacity and data throughput, thus enabling large-size over-the-air content transfer. Whereas realizing multiple antenna systems on the base-station side might require just additional cost and space, the implementation of multi-antenna architectures on a mobile terminal faces harder technological hurdles due to the aesthetic and electrical requirements, for instance, the desire to have internal antennas in a compact handset form factor while also ensuring that the antennas are uncorrelated in order to maximize the processing gains, thus the attainable data rates, provided by multi-antenna communication systems.

Substantially uncorrelated antennas are necessary for diversity or multiple input/multiple output (MIMO) operation, and for use in mobile communication devices must be far enough apart in order to be uncorrelated, or must exhibit other features, for example, polarization orthogonality to provide low correlation. The physical size of mobile communication devices does not allow for antenna to be far enough apart, especially for lower frequencies such as 800 MHz, where a half wavelength is about 18 centimeters in free space. Conventional uncorrelated antennas in mobile communication devices have required a large separation or size.

Accordingly, it is desirable to provide macro-sized RF uncorrelated antennas that may be disposed in close relationship for use with mobile communication device transmitters and/or receivers. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIG. 1 is a top view of two adjacent antennas in accordance with a first exemplary embodiment;

FIG. 2 is a perspective view of two adjacent antennas in accordance with a second exemplary embodiment

FIG. 3 is a block diagram of an antenna system including an exemplary embodiment; and

FIG. 4 is a block diagram of an electronic device including an exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Uncorrelated antennas are disclosed that may be disposed in close proximity by using the anisotropic conductivity of aligned conductive nanostructures. The nanostructures in one antenna are aligned in a first direction and the nanostructures in an adjacent antenna are aligned in a second direction substantially orthogonal to the first direction. Current flows much more easily in the direction of alignment of the nanostructures than the direction orthogonal to the alignment; therefore, the respective linear polarization of the adjacent antennas are substantially orthogonal to one another, allowing them to be placed near each other with minimum coupling and correlation even in the presence of nearby bodies, such as the body of the user of a portable communication device employing said antenna system.

Orthogonality between electrical currents supported by aligned conductive nanostructures can be interpreted in the physical-geometrical sense as done above, or more broadly in a mathematical-geometrical sense by resorting to the analytical definition of inner product, and the consequent definition of correlation coefficient between two vector current density distributions, J₁ and J₂, supported by said nano-structures

$${ρ}_{12} = \frac{〈 {J}_{1} , {J}_{2} 〉}{\sqrt{〈 {J}_{1} , {J}_{1} 〉} \sqrt{〈 {J}_{2} , {J}_{2} 〉}} ,$$

where the inner product can be defined as

$$〈 {J}_{1} , {J}_{2} 〉 = {\int }_{V} {J}_{1}^{*} \cdot {J}_{2} d V ,$$

where V is the currents domain and the symbol * represents complex conjugation. Since this correlation coefficient is related to the correlation between antennas, it is desirable that its magnitude be kept below a certain level, for instance |ρ₁₂|<0.7.

In the case of planar or substantially planar, or even cylindrical antennas realized with coherently oriented nanostructures, the antennas can be placed in the proximity of each other either laterally or vertically. In the first case, the antennas are placed next to each other so that the nanostructures of each one of them evolve in orthogonal directions. In the second case, they can be placed totally or partially on top of each other while maintaining said orthogonality. It should be observed that orthogonality is here intended either as a point by point geometrical feature of overlapping antennas nanostructures, or as a mathematical feature such as the correlation, where the correlation between the two antennas currents is carried out over the antenna domains.

By designing and tuning the length of nanostructures, e.g., carbon nanotubes, nanostructure antennas can perform in the broad wireless frequency spectrum from microwave such as 3G/WCDMA, to millimeter wave, and to terahertz and beyond. The length of the nanostructure antennas may be controlled by the basic length of the nanostructure and its nested layers ranging from tens to hundreds. The nanostructure antenna may be embedded on, or printed in, a substrate. The low power required by the nanostructure antennas is due to the skin effect, by operating in a plasmon mode with little or no loss of efficiency.

Nanostructures such as nanotubes, nanowires, and their arrays show promise for the development of macro-sized antennas and antenna arrays. Preparation of these nanostructures by chemical vapor deposition (CVD) has shown a clear advantage over other approaches. In addition, the CVD approach allows for the growth of high quality nanotubes by controlling the size, location, and pattern of catalytic nanoparticles. The growth direction of the nanotubes can be furthermore controlled by plasma-enhanced CVD processing. For example, the diameters of multi-walled nanotubes are typically proportionally related to the sizes of the catalytic nanoparticles used in the CVD process.

Carbon is one of the most important known elements and can be combined with oxygen, hydrogen, nitrogen and the like. Carbon has four known unique crystalline structures including diamond, graphite, fullerene and carbon nanotubes. In particular, carbon nanotubes typically refer to a helical tubular structure grown with a single wall or multi-wall, and commonly referred to as single-walled nanotubes (SWNTs), or multi-walled nanotubes (MWNTs), respectively. These types of nanostructures are obtained by rolling a sheet formed of a plurality of hexagons. The sheet is formed by combining each carbon atom thereof with three neighboring carbon atoms to form a helical tube. Single wall carbon nanotubes typically have a diameter in the order of a fraction of a nanometer to a few nanometers. Multiwall carbon nanotubes typically have an outer diameter in the order of a few nanometers to several hundreds of nanometers, depending on inner diameters and numbers of layers. Each layer is still a single wall of the nanotube. The multi-wall carbon nanotube with large diameter is generally longer. Carbon nanotubes can function as either a conductor, like metal, or a semiconductor, according to the rolled shape (chirality) and the diameter of the helical tubes. With metallic-like nanotubes, a carbon-based structure can conduct a current in one direction at room temperature with essentially ballistic conductance so that metallic-like nanotubes can be used as ideal interconnects, RF signal receptors, and radiation elements. It is also found that the band gap of a carbon nanotube is inversely proportional to the tube diameter. Therefore, it is necessary to keep the tube diameter small for semiconducting single wall nanotubes. Instead, a multiwall carbon nanotube with large diameter, in general, is metallic in nature. Such super metallic property is desirable to the design of nanotube antennas and phased array antennas.

Another class of one-dimensional nanostructures is nanowires. Nanowires of inorganic materials have been grown from metal (e.g., Ag,and Au), elemental semiconductors (e.g., Si, and Ge), III-V semiconductors (e.g., GaAs, GaN, GaP, InAs, and InP), II-VI semiconductors (e.g., CdS, CdSe, ZnS, and ZnSe) and oxides (e.g., SiO₂ and ZnO). Similar to carbon nanotubes, inorganic nanowires can be synthesized with various diameters and length, depending on the synthesis technique and/or desired application needs.

Both carbon nanotubes and inorganic nanowires have been demonstrated as field effect transistors (FETs) and other basic components in nanoscale electronics such as p-n junctions, bipolar junction transistors, inverters, etc. The motivation behind the development of such nanoscale components is that “bottom-up” approach to nanoelectronics has the potential to go beyond the limits of the traditional “top-down” manufacturing techniques.

Unlike other inorganic one-dimensional nanostructures, carbon nanotubes can function as either a conductor, or a semiconductor, according to the chirality and the diameter of the helical tubes. With metallic-like nanotubes, a one-dimensional carbon-based structure can conduct a current at room temperature with essentially no resistance. Further, electrons can be considered as moving freely through the structure, so that metallic-like nanotubes can be used as ideal interconnects. Therefore, carbon nanotubes are potential building blocks for nanoelectronic devices because of their unique structural, physical, and chemical properties.

In the case of carbon nanotubes, various catalytic material processes have been invoked even for a similar growth technique such as thermal chemical vapor deposition (CVD). For example, a slurry containing Fe/Mo or Fe nanoparticles served as a catalyst to selectively grow individual single walled nanotubes. However the catalytic nanoparticles usually are derived by a wet slurry route which typically has been difficult to use for patterning small features.

Another approach for fabricating nanotubes is to deposit metal films using ion beam sputtering to form catalytic nanoparticles. In an article by L. Delzeit, B. Chen, A. Cassell, R. Stevens, C. Nguyen and M. Meyyappan in Chem. Phys. Lett. 348, 368 (2002), CVD growth of single walled nanotubes at temperatures of 900° C. and above was described using Fe or an Fe/Mo bi-layer thin film supported with a thin aluminum under layer.

Ni has been used as one of the catalytic materials for the bulk formation of single walled nanotubes during laser ablation and arc discharge processes as described by Thess et al. in Science, 273, 483 (1996) and by Bethune et al. in Nature, 363, 605 (1993). Thin Ni layers have been widely used to produce multiwalled carbon nanotubes via CVD. The growth of single walled nanotubes using an ultrathin Ni/Al bilayer film as a catalyst in a thermal CVD process has been demonstrated. The Ni/Al film deposited by electron-beam evaporation allows for easier control of the thickness and uniformity of the catalyst materials (U.S. Pat. No. 6,764,874). When the substrate is heated, the Al layer melts and forms small droplets which absorb the residual oxygen inside the furnace and/or from the underlying SiO₂ layer and oxidize quickly to form thermally stable Al₂O₃ clusters. This in turn provides the support for the formation of Ni nanoparticles which catalyze the growth of single walled nanotubes. In addition to Ni, other catalysts that have been used to grow nanotubes include Fe and Co. In all cases, the catalyst region is lithographically patterned to define where the nanotubes will be grown.

One-dimensional nanostructures such as nanotubes and nanowires show promise for the development of molecular-scale antennas used in, e.g., transmitters and receivers. One-dimensional nanostructures are herein defined as a material having a high aspect ratio of greater than 10 to 1 (length to diameter) and includes at least carbon nanotubes with a single wall or a limited number of walls, carbon nanofibers, carbon nanowires, and semiconducting nanowires.

Referring to FIG. 1, an uncorrelated antenna 100 includes a pair of antennas 102, 104. Although antennas 102, 104 are described as patch antennas in this exemplary embodiment, it should be understood the antennas 102, 104 may take any type, shape, configuration, and include slot lines and the like. Antenna 102 includes a plurality of aligned nanostructures 106 substantially aligned in a first direction 110 and antenna 104 includes a second plurality of nanostructures 108 aligned in a second direction 112. The nanostructures may be formed in any known manner, for example, grown on the nanostructure substrate 114 or grown and then placed thereon. The nanostructures 106, 108 preferably will be of a determined length for the frequency of the particular application. For microwave transmissions, the length of the nanostructures 106, 108 would be in the range of 0.5 centimeters to 2.0 centimeters. For millimeter wave transmissions, the length of the nanostructures 106, 108 would be in the range of 0.05 millimeter to 0.5 centimeter. For terahertz and beyond terahertz transmissions, the length of the nanostructures 106, 108 would be in the range of 1.0 nanometer to 0.05 millimeter. The nanostructure substrate 114 may comprise most any substrate know in the semiconductor industry, e.g., glass, silicon, gallium arsenide, indium phosphide, silicon carbide, gallium nitride, and flexible materials such as Mylar® and Kapton®, but more preferably for high frequency applications comprises a material having high resistivity such as quartz or sapphire. The nanostructure substrate 114 may be positioned on a PWB substrate (not shown) preferably comprising fiberglass reinforced resin types (such as FR-4), low temperature co-fired ceramic (LTCC), liquid crystal polymer (LCP), and Teflon impregnated mesh types. An RF signal is applied to the nanostructures 106, 108 via any known connector, for example, a distributed electromagnetic coupling (not shown). A conductive layer (not shown), e.g., a catalyst, may be formed on the nanostructure substrate 114 for growing the nanostructures 106, 108. Examples of suitable catalytic material (which may comprise catalytic nanoparticles) for the catalytic layer for nanostructure growth include titanium, vanadium, chromium, manganese, copper, zirconium, niobium, molybdenum, silver, hafnium, tantalum, tungsten, rhenium, gold, ruthenium, rhodium, palladium, osmium, iridium, platinum, nickel, iron, cobalt, or a combination thereof. More particularly for carbon nanotube growth, examples include nickel, iron, and cobalt, or combinations thereof. And for silicon nanowire growth, examples include gold or silver.

Though the nanostructures 106, 108 may be grown by any method known in the industry, one preferred way of growing carbon nanotubes is as follows. A chemical vapor deposition (CVD) is performed by exposing the structure 114 (including a catalyst) to hydrogen (H₂) and a carbon containing gas, for example methane (CH₄), between 450° C. and 1,000° C., but preferably between 550° C. and 850° C. CVD is the preferred method of growth because the variables such as temperature, gas input, and catalyst may be controlled. Carbon nanotubes 106, 108 are thereby grown from the substrate 14 forming a single nanostructures or a network (i.e., mesh) of connected carbon nanotubes 106, 108. Although only a few carbon nanotubes 106, 108 are shown, those skilled in the art understand that a large number of carbon nanotubes 106, 108 could be grown. Furthermore, the carbon nanotubes are illustrated as growing in a vertical direction with plasma enhanced processing. It should be understood that they may lay in a horizontal position to form the network. The nanostructures 106, 108 may be grown in any manner known to those skilled in the art, and are grown to a desired length and diameter. Furthermore, the carbon nanotubes 106, 108 may be coupled by vias or air-bridges, for example, to other points within an integrated circuit residing on the substrate.

The distance between the antennas 102, 104 may be less than 0.1 wavelength (of the transmitted/received signal) and may be greater than 1.0 wavelength, but preferably is in the range of 01. to 1.0 wavelength. The dimension of the sides of the antennas 102, 104 shown in FIG. 1 would preferably be in the range of 0.25 to 0.50 wavelength but may be outside that range.

Current will flow easily in the direction 110, 112, but not orthogonal from one nanostructure 106, 108 to an adjacent nanostructure 106, 108. When a received RF signal strikes the nanostructures 106, antenna 102 will respond predominantly to the E field component aligned with the nanostructures 106 in the direction 110, and likewise, antenna 104 will respond predominantly to the E field component aligned with the nanostructures 108 in the direction 112. Hence, antenna decorrelation in a fully scattered 3D environment is assured via polarization diversity rather than space diversity, permitting the antennas 102, 104 to be uncorrelated despite their close proximity.

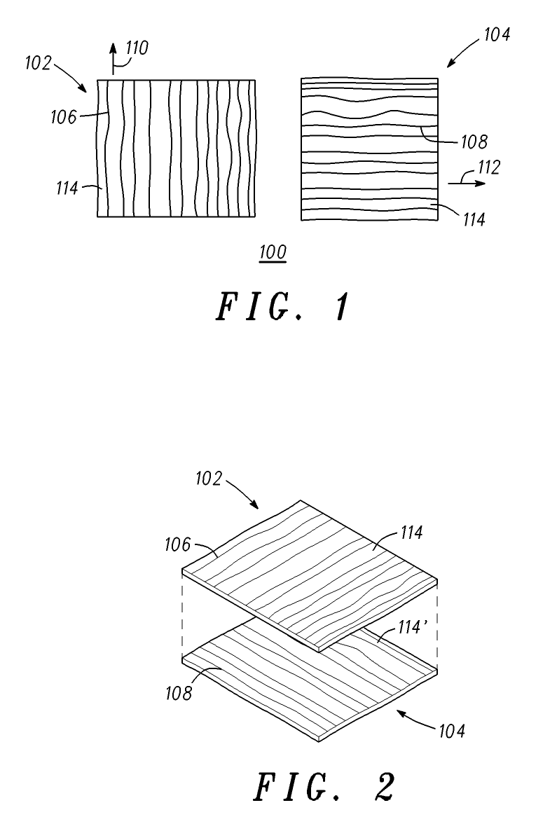

While the antennas 102, 104 in the first exemplary embodiment are disposed spaced apart in the same plane, in a second exemplary embodiment, the antennas 102, 104 may be disposed in two parallel planes in an overlying fashion (FIG. 2). The antennas 102, 104 may be formed on separate substrates or embedded in a material (not shown) disposed against one another.

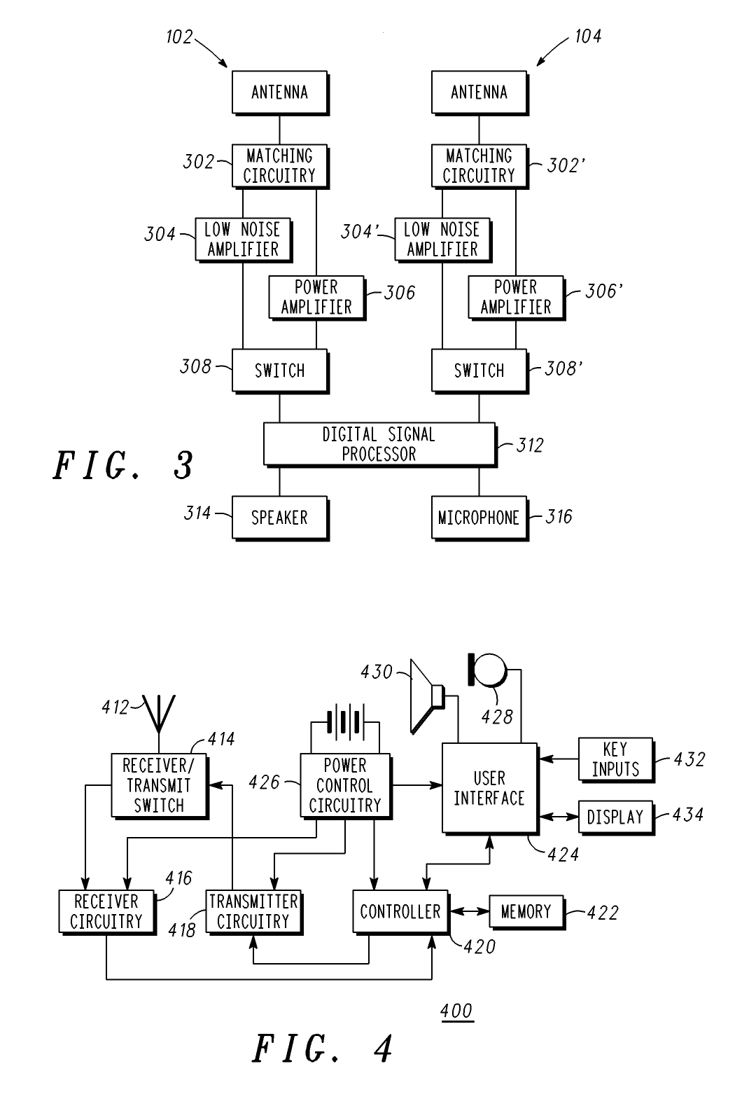

FIG. 3 is a block diagram of a transceiver exemplary embodiment incorporating the uncorrelated antenna 100 described herein. Prime numbers are used to identify circuitry associated with antenna 104 that is similar to circuitry associated with antenna 102. Each antenna is coupled to matching circuitry 302, 302′ for matching resistances therebetween. A low noise amplifier 304, 304′ and a power amplifier 306, 306′ are each coupled between a switch 308, 308′. A digital signal processor 312 is coupled between the switches 308, 308′ and both a speaker 314 and a microphone 316.

When a signal is generated, for example by the microphone 316, the digital signal processor 312 provides a digital signal to the power amplifier 306, 306′ as determined by the position of the switch 308, 308′. The signal is then transmitted from the antennas 102, 104. When a signal is received by the antennas 102, 104, the low noise amplifier 304, 304′ provides the signal, as determined by the switch 308, 308′, to the digital signal processor 312, wherein the signal is converted to analog and provided as output by the speaker 314.

The exemplary embodiments described herein are advantageous over known means of providing un-correlated antennas because the intrinsic current in the direction of the nanostructures provide explicit control of the currents in close proximity. Previously known antennas must control currents (and hence correlation) through greater spacing, gross shapes and resonant of resonant structures, and other means that increase the size of the antenna system.

Referring to FIG. 4, a block diagram of a portable communication device 400 such as a cellular phone, in accordance with the preferred embodiment of the present invention is depicted. The portable electronic device 400 includes an antenna 412 for receiving and transmitting radio frequency (RF) signals, which may comprise any embodiments within the present invention. A receive/transmit switch 414 selectively couples the antenna 412 to receiver circuitry 416 and transmitter circuitry 418 in a manner familiar to those skilled in the art. The receiver circuitry 416 demodulates and decodes the RF signals to derive information therefrom and is coupled to a controller 420 for providing the decoded information thereto for utilization thereby in accordance with the function(s) of the portable communication device 410. The controller 420 also provides information to the transmitter circuitry 418 for encoding and modulating information into RF signals for transmission from the antenna 412. As is well-known in the art, the controller 420 is typically coupled to a memory device 422 and a user interface 424 to perform the functions of the portable electronic device 410. Power control circuitry 426 is coupled to the components of the portable communication device 410, such as the controller 420, the receiver circuitry 416, the transmitter circuitry 418 and/or the user interface 424, to provide appropriate operational voltage and current to those components. The user interface 424 includes a microphone 428, a speaker 430 and one or more key inputs 432, including a keypad. The user interface 424 may also include a display 434 which could include touch screen inputs.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. An uncorrelated antenna system comprising:
a first antenna comprising a first plurality of elongated nanostructures aligned in a first direction; and
a second antenna spatially disposed from the first antenna and comprising a second plurality of elongated nanostructures aligned in a second direction substantially orthogonal to the first direction.

2. The uncorrelated antenna system of claim 1 wherein each of the first and second antennas comprise sides having a dimension in the range of 0.25 to 0.5 wavelength of the signal.

3. The uncorrelated antenna system of claim 1 wherein each of the first and second antennas comprise first and second antennas for transmitting a signal and are spaced apart within the range of 0.1 to 1.0 wavelength of the signal.

4. The uncorrelated antenna system of claim 1 wherein each of the first and second plurality of elongated nanostructures comprise carbon nanotubes.

5. The uncorrelated antenna system of claim 1 wherein each of the first and second antennas comprise first and second antennas for receiving a signal, wherein orthogonal E polarizations are created in the first and second antennas when the signal is received.

6. The uncorrelated antenna system of claim 1 further comprising:
a digital signal processor; and
a first low noise amplifier coupled between the first antenna and the digital signal processor; and
a second low noise amplifier coupled between the second antenna and the digital signal processor.

7. The uncorrelated antenna system of claim 1 further comprising:
a digital signal processor; and
a first power amplifier coupled between the first antenna and the digital signal processor; and
a second power amplifier coupled between the second antenna and the digital signal processor.

8. The uncorrelated antenna system of claim 1 wherein the first and second antennas are disposed in the same plane.

9. The uncorrelated antenna system of claim 1 wherein the first and second antennas are disposed in parallel planes.

10. A pair of antennas comprising:
a first plurality of nanostructures aligned in a first direction; and
a second plurality of nanostructures spaced from the first plurality of nanostructures and aligned in a second direction orthogonal to the first direction.

11. The pair of antennas of claim 10 wherein each of the first and second plurality of nanostructures comprise carbon nanotubes.

12. The pair of antennas of claim 10 wherein each of the first and second antennas comprise first and second antennas for receiving a signal, wherein, when the signal is received, an E polarization created in the first antenna is orthogonal to an E polarization created in the second antenna.

13. An uncorrelated antenna system comprising:
a first antenna comprising elongated nanostructures; and
a second antenna comprising elongated nanostructures having a correlation coefficient of currents with a magnitude less than 0.7.

14. The pair of antennas of claim 13 wherein each of the first and second antennas comprise sides having a dimension in the range of 0.25 to 0.5 wavelength of the signal.

15. The pair of antennas of claim 13 wherein each of the first and second antennas comprise first and second antennas for transmitting a signal and are spaced apart within the range of 0.1 to 1.0 wavelength of the signal.

16. The pair of antennas of claim 13 wherein each of the first and second plurality of nanostructures comprise carbon nanotubes.

17. The pair of antennas of claim 13 wherein each of the first and second antennas comprise first and second antennas for receiving a signal, wherein, when the signal is received, an E polarization created in the first antenna is orthogonal to an E polarization created in the second antenna.

18. The pair of antennas of claim 13 wherein the first and second antennas are disposed in the same plane.

19. The pair of antennas of claim 13 wherein the first and second antennas are disposed in parallel planes.

20. The uncorrelated antenna system of claim 13 further comprising:
a digital signal processor; and
a first low noise amplifier coupled between the first antenna and the digital signal processor; and
a second low noise amplifier coupled between the second antenna and the digital signal processor.

21. The uncorrelated antenna system of claim 13 further comprising:
a digital signal processor; and
a first power amplifier coupled between the first antenna and the digital signal processor; and
a second power amplifier coupled between the second antenna and the digital signal processor.
